(19) United States
(12) Patent Application Publication
(10) Pub. No.: US 2026/0361739 A1
(43) Pub. Date: Nov. 12, 2026

(54) System and method for implementing frameshifted identifiers to mitigate malware threats

(71) Applicant: Bank of America Corporation, Charlotte, NC (US)

(72) Inventors: Saurabh Gupta, Dwarka (IN); Shailendra Singh, Maharashtra (IN)

(21) Appl. No.: 19/203,558

(22) Filed: May 9, 2025

(51) Int. Cl. H04L 9/40; G06K 7/14; G06K 19/06; H04L 9/32

(52) U.S. Cl. CPC H04L 63/1425; G06K 7/1417; G06K 19/06037; H04L 9/3213

(57) ABSTRACT

A system for implementing frameshifted identifiers to mitigate malware threats. The system receives the image of the first QR code from a user device in response to an interaction initiated between a user device and a terminal device of the plurality of terminal devices. The interaction is initiated by the user device capturing the image of the first QR code displayed at the terminal device. The system extracts the terminal device identifier from the image of the first QR code and accesses a first set of past interactions from the plurality of past interactions performed by the terminal device. The system is configured to modify the first QR code by replacing the first dynamic placeholder with a first non-fungible token (NFT) and replacing the second dynamic placeholder with a second NFT to generate a second QR code.

### TECHNICAL FIELD

The present disclosure relates generally to information security, and more particularly, to a system and method for implementing frameshifted identifiers to mitigate malware threats.

### BACKGROUND

In a network environment, user devices interact with terminal devices. These network environments allow wireless interaction between the user and terminal devices. These wireless interactions utilize operation identifiers, such as quick response (QR) codes, bar codes, and the like, to direct user devices to a particular website or to communicate particular data to user devices that are used to scan the operation identifiers. For example, QR code fraud is emerging as a significant source of fraud. Bad actors are circulating fraudulent QR codes to misdirect data from user accounts. A bad actor may use a fraudulent QR code or barcode, as part of a malware attack, to gain unauthorized access to information associated with users. The fraudulent QR codes may lead to the installation of malware on the user device as part of a malware attack, or in other cases, may lead users who scan the fraudulent QR code to a phishing or malicious website designed to collect private information from the users. Existing systems are unable to detect or mitigate such malware attacks associated with fraudulent QR codes before an attack. Existing systems rely on system failure reports from user devices, after an attack, to detect malware attacks. Hence, by the time these failure reports are received, the attack has done at least some of its intended damage.

### SUMMARY

The system described in the present disclosure is particularly integrated into a practical application of implementing a frameshifted identifier to mitigate malware threats and provide optimized security from fraudulent operation identifiers (e.g., fraudulent QR codes or fraudulent barcodes). This practical application provides several technical advantages, including reducing fraudulent activities performed by fraudulent QR codes and improving the security and privacy of user devices and user information stored at the user devices that could otherwise be accessed by fraudulent QR codes.

In general, the disclosed system transforms a legacy QR code associated with a terminal device to generate an incomplete QR code. The legacy code is transformed by applying frameshifting techniques (i.e., altering the legacy QR code by inserting dynamic placeholders) to generate the incomplete QR code. The system transmits the incomplete QR code to the terminal device. The incomplete QR code includes a terminal device identifier and dynamic placeholders. The terminal device displays the incomplete QR code, and the user device scans the incomplete QR code (by taking an image of the incomplete QR code using a camera on the user device) to initiate an interaction. The system receives the scanned image of the incomplete QR code from the user device in response to an interaction initiated between the user device and the terminal device. Since the incomplete QR code has dynamic placeholders included in it, the system is configured only to allow the interaction to proceed for authentication in response to an incomplete QR code being modified (by filling in the dynamic placeholders) into a complete QR code. The system determines if the dynamic placeholders can be filled based on past interaction data associated with the terminal device identifier included in the incomplete QR code. If the past interaction data includes, for example, indicators of reported fraud interactions, then the incomplete QR code is determined as a fraudulent QR code, and the interaction is denied. However, if the past interaction data indicates that the past interactions are not fraudulent interactions (i.e., they are legitimate interactions), then it is determined that the incomplete QR code is not a fraudulent QR code. Thus, the dynamic placeholders within the incomplete QR code are filled with the past interaction data to generate a complete QR code, and the interaction is allowed to proceed for authentication. Thus, the system only allows the interaction to proceed in response to an incomplete QR code being modified into a complete QR code. This provides the technical advantage of not allowing or processing requests from fraudulent QR codes. This, in turn, provides technical improvements and advantages over the current operation identifier implementation techniques.

Conventional technologies are unable to detect or mitigate such malware attacks associated with fraudulent QR codes before an attack and thus are not configured to protect the user devices from such malware attacks. When the user device scans a fraudulent QR code, it may lead to the unauthorized installation of malware (malicious software) on the user device as part of a malware attack. The malware is configured to perform malicious activities to disrupt the operations of the user device, for example, by creating unwanted files to slow down the speed and performance of the user device, corrupting files, or crashing some software or executable applications so that they cannot be executed. When a malware attack infects the user device, it usually spreads by duplicating itself and hiding in the device’s data files. A malware attack often results in compromised computing performance by causing slow processor performance, and data redirects, frequent infection warnings, problems starting up and shutting down user devices, sudden loss of memory disk space, repeated system crashes and freezes, disabled security features, changes in a file name and sizes, programs opening and closing themselves, or a combination thereof. In some cases, malware attacks can lock up user devices, making them unusable. In another example, malware attacks may include accessing sensitive data, such as personal information, without authorization. In another example, a malware attack may exfiltrate data by transmitting confidential data to unauthorized devices. In some cases, the stolen data may be used to perform other unauthorized data interactions within the computing infrastructure and to gain access to of different devices (e.g., wirelessly connected cameras) associated with the user device and cause damage (e.g., data theft, compromised computing performance, device failure etc.) to those other computing nodes. Current QR code-related malware attack detection techniques suffer from several drawbacks in detecting such attacks. For example, the current malware attack detection techniques cannot detect malware attacks before the attack has done its intended damage. The current malware attack detection techniques rely on system failure reports to detect the malware attack after the attack. By the time these failure reports are received, the attack has done its intended damage. Thus, the current malware attack detection techniques are retroactive, meaning that the attack is detected after it has done its intended damage.

Unlike conventional systems where a malware attack is detected after damage to the user device has taken place, the disclosed system and methods determine a fraudulent QR code before allowing an interaction initiated between the user device and the terminal device to proceed. Specifically, the disclosed system determines if the scanned incomplete QR code is a fraudulent QR code, based on past interaction data associated with the terminal device identifier included in the incomplete QR code. In response to determining that the incomplete QR code is associated with a bad actor and thus is a fraudulent QR code, the system denies the initiated interaction. Thus, the disclosed system proactively detects a malware attack and stops damage from occurring because of the malware attack. By denying the initiated interaction associated with a fraudulent terminal device, bad actors are restricted from gaining access to the user device and from installing malware on the user device. By avoiding a malware attack on the server device, the disclosed system mitigates damage to the user device that may otherwise occur due to malware being installed on the user device. For example, avoiding a malware attack may avoid several types of damage typically caused by a malware attack, including, but not limited to, compromised computing performance, including slow processor performance, data redirects, frequent infection warnings, problems starting up and shutting down of user device, sudden loss of memory disk space, repeated system crashes and freezes, disabled security features, changes in file name and sizes, programs opening and closing themselves, or a combination thereof.

In another situation, when the user device scans a fraudulent QR code, it may lead the user device to a phishing or malicious website designed to collect private information from the user of the user device. When user devices are affected by a malware attack, the attack performs harmful actions, such as system damage. System damage occurs when the malware deletes data or modifies the source code of the user device, leading to unstable or unusable systems. Another example of harmful action is data exfiltration. Data exfiltration occurs when the malware steals sensitive information (such as emails, passwords, financial information, etc.) stored on the user device. To remedy such harmful actions (i.e., system damage and data exfiltration), the affected user device must be taken offline until the root problem is identified, thus making it unavailable until the problem is identified and remedied. Thus, the disclosed system provides a technical solution of only allowing an interaction initiated between the user device and the terminal device to proceed in response to an incomplete QR code being modified into a complete QR code. Specifically, the disclosed system determines if the scanned incomplete QR code is a fraudulent QR code, based on past interaction data associated with the terminal device identifier included in the incomplete QR code. In response to determining that the incomplete QR code is a fraudulent QR code, the system detects a malware attack and stops damage from occurring before the attack. The harmful action of system damage is thus evaded, saving downtime associated with the affected user device. This leads to improved operational efficiency of the user device because the user device is not required to be taken offline for remediation.

In this manner, certain embodiments may enable the detection of a malware attack and stop damage from occurring before the attack, thereby helping to reduce the probability of bad actors gaining access to the user device. In particular, certain embodiments may aid in providing improved security to the user device by helping to reduce the likelihood of virus and/or malware infections. This in turn may (1) conserve processing and memory resources that would otherwise be consumed by the viruses/malware operating within the system, (2) allow the software installed on that system to run faster and smoother, avoiding system crashes/failures that may be caused by the viruses/malware, (3) conserve networking resources that may otherwise be expended by the virus/malware communicating with other systems (e.g., in an attempt to infect those other systems), and (4) protect data stored within the system from corruption by the viruses/malware, avoiding the need to expend computational resources in reproducing corrupted data.

In some embodiments, a system for implementing frameshifted identifiers to mitigate malware threats includes a memory operably coupled with a processor. The memory is configured to a first quick response (QR) code and a plurality of past interactions. The plurality of past interactions are performed by a plurality of terminal devices. The processor is configured to electronically receive the image of the first QR code from a user device in response to an interaction initiated between a user device and a terminal device of the plurality of terminal devices. The interaction is initiated by the user device capturing the image of the first QR code displayed at the terminal device. The first QR code includes a terminal device identifier that identifies the terminal device and a plurality of dynamic placeholders and each of the plurality of dynamic placeholders comprises a blank area in the first QR code. The processor is configured to decode the first QR code and extract the terminal device identifier from the image of the first QR code and access a first set of past interactions from the plurality of past interactions performed by the terminal device. The first set of past interactions are identified from the plurality of past interactions based on the extracted terminal device identifier. The processor is configured to determine whether at least one of the first set of past interactions is included in a plurality of fraudulent interactions stored in the fraudulent interaction database. The processor is configured to select a first pair of placeholders from the plurality of dynamic placeholders that are to be replaced in response to determining that none of the first set of past interactions are included in the plurality of fraudulent interactions. The first pair of placeholders comprises a first dynamic placeholder and a second dynamic placeholder and the first pair of placeholders are selected at non-consecutive time instants. The processor is further configured to modify the first QR code by replacing the first dynamic placeholder with a first non-fungible token (NFT) and replacing the second dynamic placeholder with a second NFT to generate a second QR code. The first NFT comprises a first interaction data from the first set of past interactions and the second NFT comprises a second interaction data from the first set of past interactions. The processor is further configured to allow the initiated interaction between the user device and the terminal device to proceed with authenticating the interaction and transmit the second QR code to the user device in response to generating the second QR code.

Some embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of embodiments of the disclosure and the potential advantages thereof, reference is now made to the following written description taken in conjunction with the accompanying drawings, in which:

FIG. 1 illustrates an embodiment of a system configured to implement a frameshifted identifier to mitigate malware threats;

FIGS. 2A-2F illustrates an example operational flow of the system of FIG. 1 for implementing a frameshifted identifier to mitigate malware threats; and

FIGS. 3A-3B illustrates an example flowchart of a method of the system of FIG. 1 for implementing a frameshifted identifier to mitigate malware threats.

### DETAILED DESCRIPTION OF THE DRAWINGS

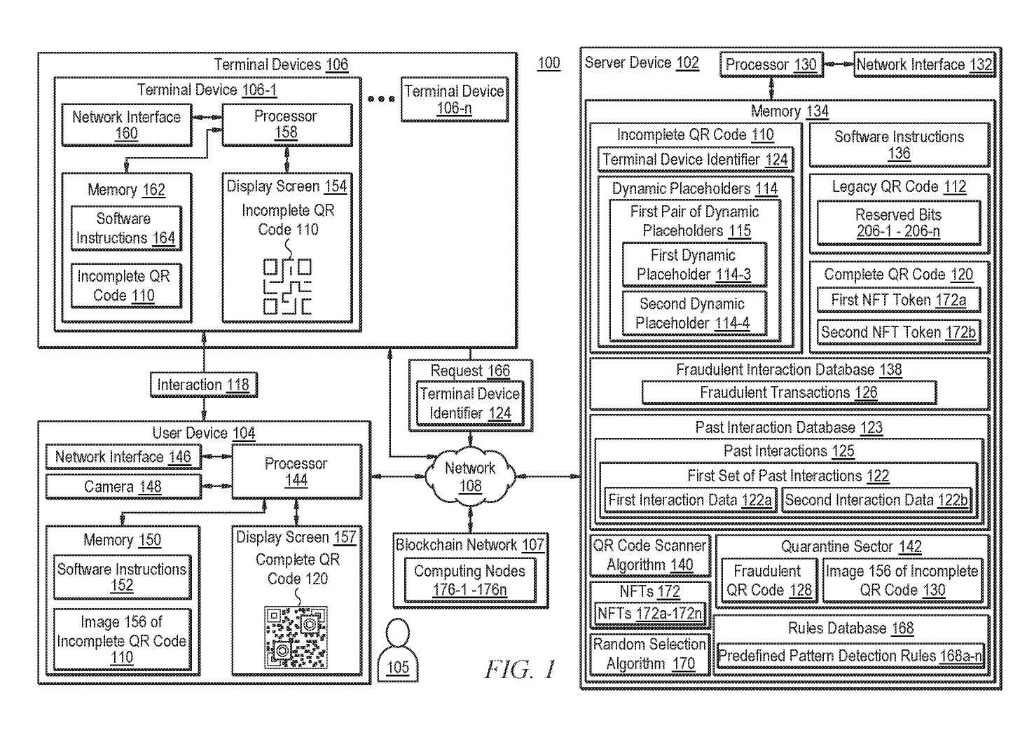

As described above, previous technologies fail to provide efficient and reliable solutions to implement a frameshifted identifier to mitigate malware threats. Embodiments of the present disclosure and its advantages may be understood by referring to FIGS. 1-3B. FIGS. 1-3B are used to describe systems and methods to implement a frameshifted identifier to mitigate malware threats, according to some embodiments.

### System overview

FIG. 1 is a schematic diagram of a system 100, in accordance with certain aspects of the present disclosure. As shown, system 100 includes a server device 102, user device 104, terminal devices 106-1 to 106-n, a blockchain network 107 operably connected to one another and communicating via a network 108. Network 108 enables communication among the components of the system 100. In other embodiments, system 100 may include other elements instead of, or in addition to, those listed above. The terminal devices 106-1 to 106-n are collectively also referred to as the terminal devices 106. Further, user 105 is associated with user device 104.

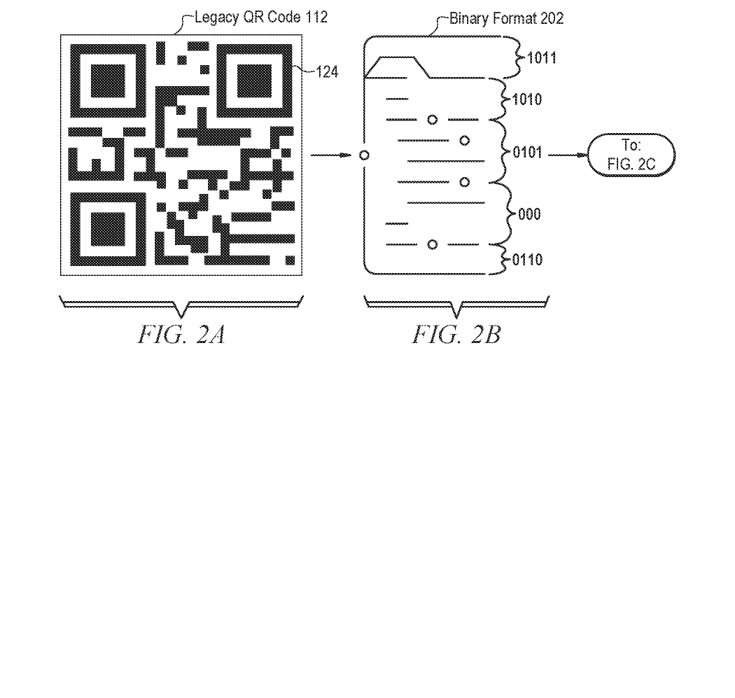

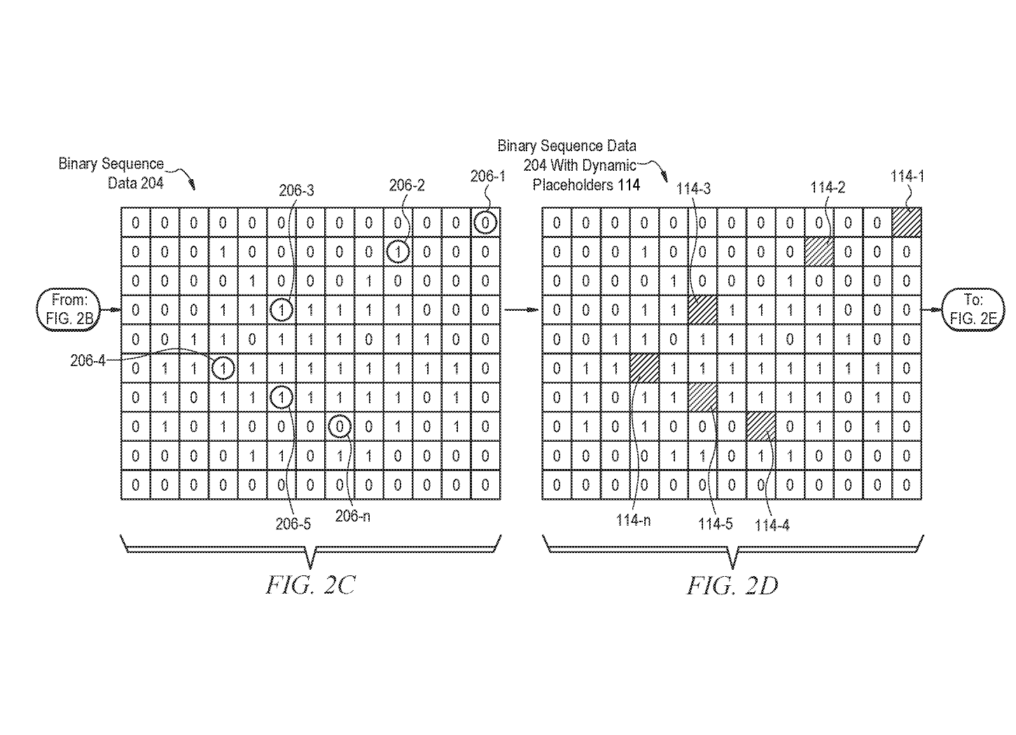

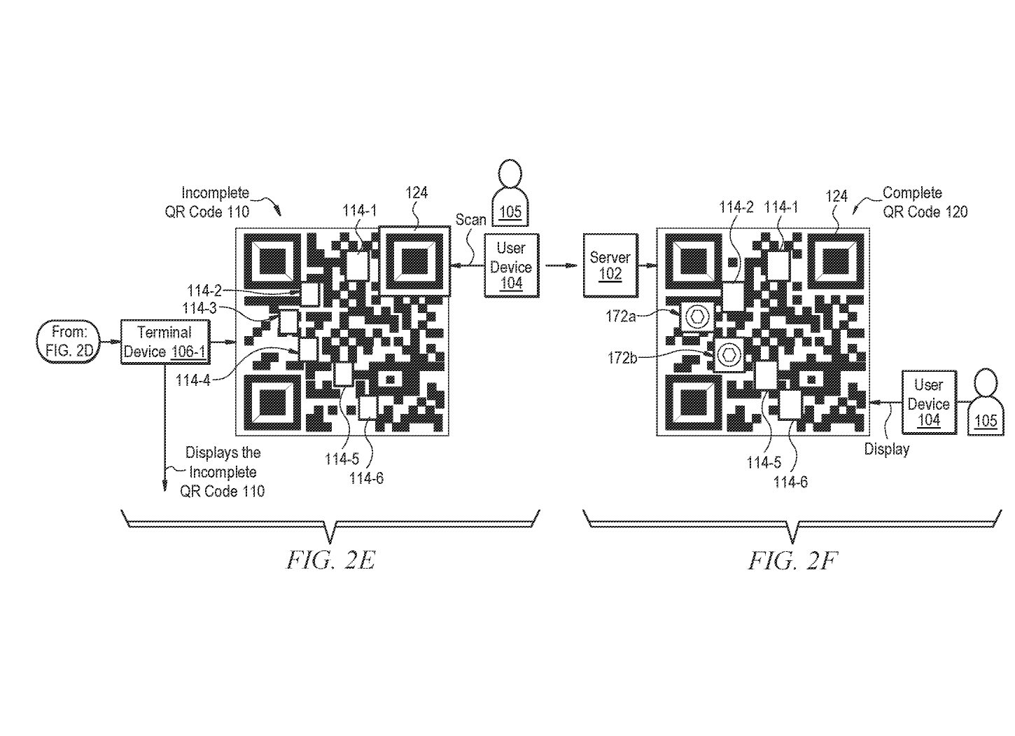

In general, the working of system 100 is initiated by the server device 102 and is performed in two phases. In the first phase, server device 102 generates an incomplete QR code 110 associated with one of the terminal devices 106 (e.g., terminal device 106-1). This incomplete QR code 110 is generated by converting a legacy QR code 112 into the incomplete QR code 110 by applying frameshifting techniques (i.e., altering the legacy QR code 112 by inserting dynamic placeholders 114) and transmitting the incomplete QR code 110 to the terminal device 106-1, explained in detail below with reference to FIG. 2. In the second phase, server device 102 receives the scanned image 156 of the incomplete QR code 110 from the user device 104 in response to an interaction 118 initiated between the user device 104 and the terminal device 106-1. In this second phase, server device 102 converts the incomplete QR code 110 into a complete QR code 120 to allow the interaction 118 to proceed for authentication.

Specifically, in the second phase, since the incomplete QR code 110 has dynamic placeholders 114 included in it, the system 100 is configured only to allow the interaction 118 to proceed in response to an incomplete QR code 110 being modified (by filling in the dynamic placeholders 114) into a complete QR code 120. The system 100 determines if the dynamic placeholders 114 can be filled based on first set of past interactions 122 (stored in the past interaction database 123) associated with the terminal device identifier 124 included in the incomplete QR code 110. If the first set of past interactions 122 associated with the terminal device 106-1 includes, for example, reported fraudulent interactions 126, then the incomplete QR code 110 is determined as a fraudulent QR code 128, and the interaction 118 is denied. However, if the first set of past interactions 122 does not include fraudulent interactions 126 (i.e., the first set of past interactions 122 are legitimate interactions), then it is determined that the incomplete QR code 110 is not associated with a bad actor. Thus, the dynamic placeholders 114 within the incomplete QR code 110 are filled with the first set of past interactions 122 to generate a complete QR code 120, and the interaction 118 is allowed to proceed for authentication.

Thus, the system 100 only allows the interaction 118 to proceed in response to an incomplete QR code 110 being modified into a complete QR code 120. This provides the technical advantage of not allowing or processing requests from fraudulent QR codes 128. This, in turn, provides technical improvements and advantages over the current operation identifier implementation techniques. Thus, the disclosed system proactively detects a malware attack from (bad actors associated with the fraudulent QR code 128) and stops damage from occurring before the malware attack.

### SYSTEM COMPONENTS

### Server device

The server device 102 includes a processor 130 and a network interface 132 in signal communication with a memory 134. Memory 134 stores software instructions 136 that, when executed by processor 130, cause processor 130 to perform one or more operations of the server device 102 described herein.

### Processor

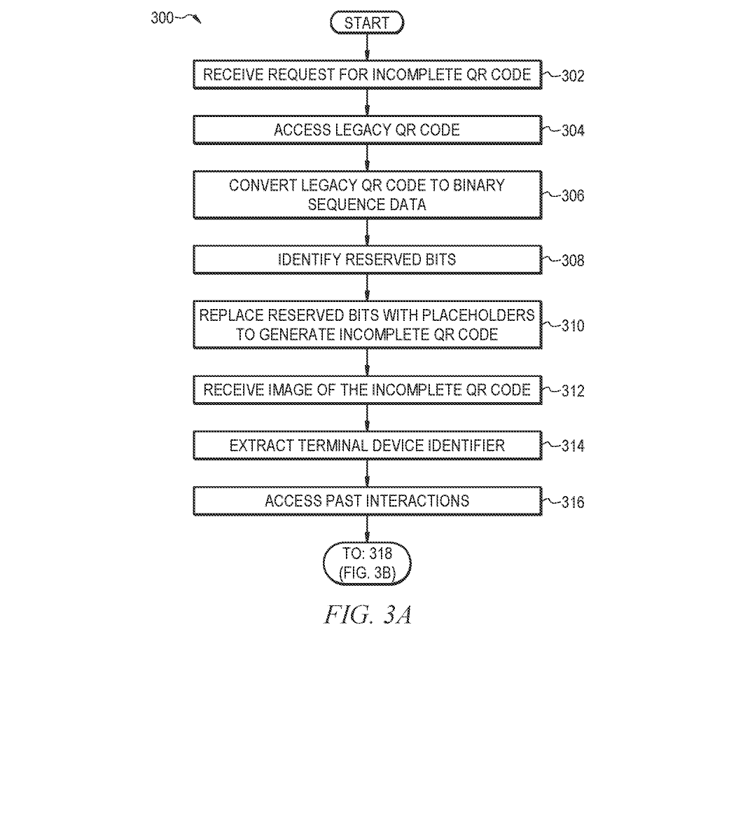

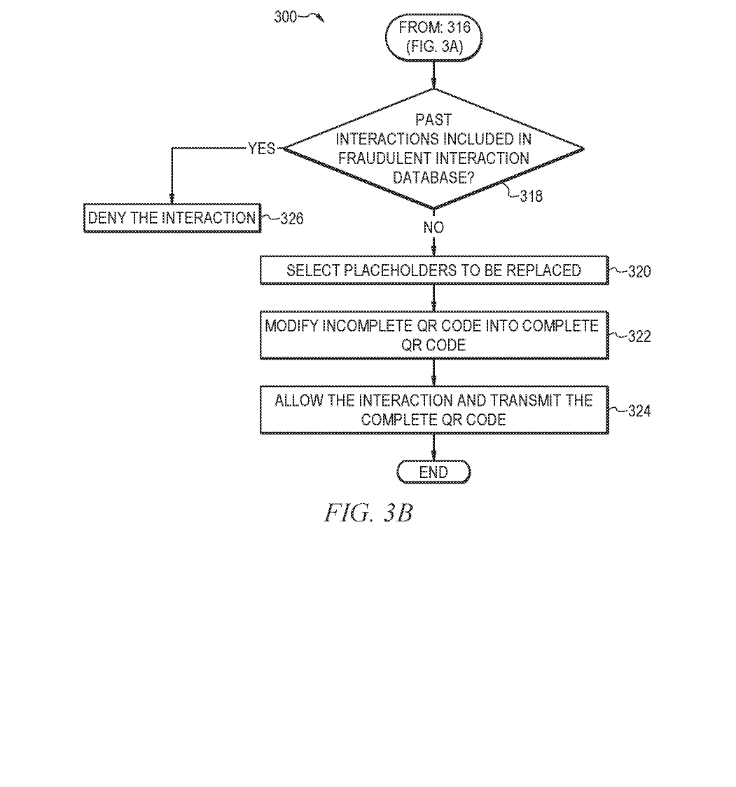

Processor 130 includes one or more processors. Processor 130 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, one or more processors are configured to execute instructions (e.g., software instructions 136) to perform the operations of the server device 102 described herein. The processor 130 is configured to operate as described in FIGS. 1-3B. For example, processor 130 may be configured to perform one or more operations of method 300 as described in FIGS. 3A-3B.

### Network interface

The network interface 132 may include an NFC interface, a Bluetooth® interface, a Zigbee® interface, a Z-wave® interface, a radio-frequency identification (RFID®) interface, a WIFI® interface, a local area network (LAN) interface, a wide area network (WAN) interface, a metropolitan area network (MAN) interface, a personal area network (PAN) interface, a wireless PAN (WPAN) interface, a modem, a switch, and/or a router. Network interface 132 is configured to enable wired and/or wireless communications. The network interface 132 may be configured to communicate data between the server device 102 and other devices, systems, or domains. The processor 130 may be configured to send and receive data using the network interface 132 and/or the network 108. The network interface 132 may be configured to use any suitable type of communication protocol.

### Memory

The memory 134 may be volatile or non-volatile and may comprise read-only memory (ROM), random-access memory (RAM), ternary content-addressable memory (TCAM), dynamic random-access memory (DRAM), and static random-access memory (SRAM). The memory 134 may include one or more of a local database, a cloud database, a network-attached storage (NAS), etc. The memory 134 comprises one or more disks, tape drives, or solid-state drives and may be used as an over-flow data storage device to store programs when such programs are selected for execution and to store instructions and data that are read during program execution. Memory 134 may store any of the information described in FIGS. 1-3B, along with any other data, instructions, logic, rules, or code operable to implement the function(s) described herein when executed by processor 130. For example, memory 134 may store incomplete QR code 110, legacy QR code 112, complete QR code 120, past interaction database 123, software instructions 136, fraudulent interaction database 138, QR code scanner algorithm 140, quarantine sector 142, rules database 168, random selection algorithm 170, non-fungible tokens (NFTs) 172, and/or any other data or instructions. The software instructions 136 may include any suitable set of instructions, logic, rules, or code operable to execute the processor 130 and perform the functions described herein, such as some or all of those described in FIGS. 1-3B.

### User Device

A user device 104 is generally any device that is configured to process data and interact with users 105. Examples of the user device 104 include but are not limited to, a personal computer, a desktop computer, a workstation, a server, a laptop, a tablet computer, a mobile phone (such as a smartphone), a virtual reality device, an augmented reality device, an Internet-of-Things (IoT) device, a wearable computing device, smart glasses, smart watches or bracelets, phablets, other smart devices, devices configured for wired or wireless RF (Radio Frequency) communication, or any other suitable type of device. The user device 104 may include a user interface, such as a display, a microphone, a camera, a keypad, or other appropriate terminal equipment usable by users. The user device 104 may include a processor 144 operably coupled with a network interface 146, a camera 148, and memory 150, configured to perform any of the functions of the user device 104 described herein. The user device 104 is configured to communicate with other devices and components of the system 100 via the network 108. For example, the user device 104 may capture an image of the incomplete QR code 110 and may cause the transmission of the image of the incomplete QR code 110 to the server device 102 by executing software instructions 152 via the network 108. Further, the user device 104 is configured to receive the complete QR code 120 from the server device 102. User device 104 is configured to display the complete QR code 120 on the display screen 157.

Although the system 100 shows one user device 104, a plurality of user devices 104 may also be included that communicate over the network 108 with server device 102 and terminal devices 106.

The user device 104 may include a software application that utilizes the server device 102 to scan the incomplete QR code 110, by transmitting the image of the incomplete QR code 110 to the server device 102. Further, at least a portion of the incomplete QR code 110 is displayed on the terminal device 106-1 (or any of the terminal devices 106) and the terminal device 106-1 is within a threshold distance (e.g., 10 inches, 20 inches, etc.) from the user device 104. For example, when it is desired to scan the incomplete QR code 110, the user 105 may aim the camera 148 of the user device 104 toward a display screen 154 of the terminal device 106-1 where at least a first portion of the incomplete QR code 110 is displayed. The camera 148 may capture the image 156 of the incomplete QR code 110 and transmit it to the processor 144 for processing. The processor 144 is configured to transmit the image 156 of the incomplete QR code 110 to the server device 102 to cause the server device 102 to perform one or more of its functions described herein. This operation is described in FIGS. 3A-3B in greater detail.

Camera 148 may be or include any camera that is configured to capture images of a field of view in front of the camera 148. Examples of the camera 148 may include charge-coupled device (CCD) cameras and complementary metal-oxide semiconductor (CMOS) cameras. The camera 148 is a hardware device that is configured to capture image 156 continuously, at predetermined intervals, or on-demand. For example, when the camera 148 is aimed toward the terminal device 106-1, the camera 148 may capture the image 156 of at least a portion of the incomplete QR code 110 that is displayed on the display screen 154.

The memory 150 may store any of the information described in FIGS. 1-3 along with any other data, instructions, logic, rules, or code operable to implement the function(s) described herein when executed by processor 144. For example, the memory 150 may store software instructions 152, image 156 (or images 156) of the incomplete QR code 110, and/or any other data or instructions. The software instructions 152 may comprise any suitable set of instructions, logic, rules, or code operable to execute the processor 144 and perform the functions described herein, such as some or all of those described in FIGS. 1-3.

### Terminal devices

A terminal devices 106 are generally any device that is configured to process data and interact with users. Examples of the terminal devices 106 include but are not limited to, a personal computer, a desktop computer, a workstation, a server, a laptop, a tablet computer, a mobile phone (such as a smartphone), a virtual reality device, an augmented reality device, automated teller machine, a point of sale device, an Internet-of-Things (IoT) device, a wearable computing device, smart glasses, smart watches or bracelets, phablets, other smart devices, devices configured for wired or wireless RF (Radio Frequency) communication, or any other suitable type of device. The terminal devices 106 may include a user interface, such as a display, a microphone, a camera, a keypad, or other appropriate terminal equipment usable by users. For example, terminal device 106-1 may include a processor 158 operably coupled with a network interface 160 and memory 162, configured to perform any of the functions of the terminal device 106-1 described herein. Similar to terminal device 106-1, terminal device 106-n may also include a processor operably coupled with a network interface and memory (not shown), configured to perform any of the functions of the terminal device 106-n. The terminal devices 106 are configured to communicate with other devices and components of the system 100 via the network 108. For example, the terminal devices 106 may receive the incomplete QR code 110 from server device 102 and display it at the display screen 154

The memory 162 may store any of the information described in FIGS. 1-3 along with any other data, instructions, logic, rules, or code operable to implement the function(s) described herein when executed by processor 158. For example, the memory 162 may store software instructions 164, the incomplete QR code 110, and/or any other data or instructions. The software instructions 164 may comprise any suitable set of instructions, logic, rules, or code operable to execute the processor 158 and perform the functions described herein, such as some or all of those described in FIGS. 1-3.

### Network

Network 108 may be any suitable type of wireless and/or wired network. The network 108 may be connected to the Internet or public network. Network 108 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., Wireless Fidelity (WiFi®), Wireless Gigabit (WiGig®), Worldwide Interoperability for Microwave Access (WiMAX®), etc.), a long-term evolution (LTE) network, a universal mobile telecommunications system (UMTS) network, a peer-to-peer (P2P) network, a Bluetooth® network, a near-field communication (NFC) network, and/or any other suitable network. The network 108 may be configured to support any suitable type of communication protocol, as would be appreciated by one of ordinary skills in the art. The user device 104 and the terminal devices 106, blockchain network 107, communicate with each other using the network 108.

### Initiate implementing a frameshifted identifier to mitigate malware threats

The disclosed system 100 provides optimized security from fraudulent operation identifiers, for example, fraudulent QR codes 128, to mitigate malware threats in two phases. In a first phase, server device 102 generates an incomplete QR code 110 for one of the terminal devices 106 (e.g., terminal device 106-1). This incomplete QR code 110 is generated by converting a legacy QR code 112 into the incomplete QR code 110 by applying frameshifting techniques (i.e., altering the legacy QR code 112 by inserting dynamic placeholders 114) and transmitting the incomplete QR code 110 to the terminal device 106-1. The first phase is now explained in detail below with reference to FIG. 2.

### First phase: Generate an incomplete QR code

Processor 130 of server device 102 receives a request 166 from one of the terminal devices 106 (e.g., terminal device 106-1) to receive an incomplete QR code 110. The incomplete QR code 110 is utilized by terminal devices 106 to display the incomplete QR code 110 on the display screen 154. For example, by displaying the incomplete QR code, terminal device 106-1 allows user device 104 to initiate the interaction 118 with terminal device 106-1. The request 166 may include an identifier (e.g., terminal device identifier 124) associated with the terminal device 106-1 that sends the request 166.

### Identify reserved bits from the legacy QR code

In response to receiving request 166, processor 130 identifies the terminal device identifier 124 included in the request 166 and accesses (from the memory 134) a legacy QR code 112 associated with the terminal device identifier 124. The legacy QR code 112 includes the terminal device identifier 124. Processor 130 is configured to store a corresponding legacy QR code 112 for each of the terminal devices 106 with a corresponding identifier associated with the terminal devices 106. Processor 130 identifies the legacy QR code 112 corresponding to the terminal device identifier 124 received in the request 166. With reference to FIG. 2A, upon accessing the legacy QR code 112 corresponding with the terminal device 106-1, processor 130 converts the legacy QR code 112 (e.g., by decoding the legacy QR code 112) into a binary format 202. The binary format 202 represents a binary format version of the legacy QR code 112. FIG. 2C shows a binary sequence data 204 included within the binary format 202. The binary sequence data 204 represents rows and columns of binary bits (0 or 1) associated with the legacy QR code 112. Each cell within the rows and columns of the binary sequence data 204 represents binary bits (0 or 1) associated with the information included in the legacy QR code 112. The processor 130 is configured to identify a cell within the binary sequence data 204 based on identifying one or more reserved bits from each row or column of the binary sequence data 204. Processor 130 is configured to identify one or more reserved bits 206-1 to 206-n within each row or column of the binary sequence data 204 based on predefined pattern detection rules 168a-n stored in the rules database 168. For example, the predefined pattern detection rules 168a-n may include identifying from the first row the last bit (e.g., 206-1) as a reserved bit, identifying from the second row the fourth last bit (e.g., 206-2) as another reserved bit, although any other bit from the binary sequence data 204 may also included in the predefined pattern detection rules 168a-n to be identified as a reserved bit. Accordingly, in this example, based on predefined pattern detection rules 168a-n, processor 130 identifies from the binary sequence data 204 reserved bits 206-1 to 206-n.

### Insert placeholders to generate an incomplete QR code

With reference to FIG. 2D, in response to identifying the reserved bits 206-1 to 206-n, processor 130 is configured to modify the legacy QR code 112 by replacing each of the reserved bits 206-1 to 206-n with a corresponding dynamic placeholder 114-1 to 114-n to generate the incomplete QR code 110. The plurality of dynamic placeholders 114-1 to 114-n are collectively referred to as dynamic placeholders 114. For example, reserved bit 206-1 corresponds to dynamic placeholder 114-1, reserved bit 206-2 corresponds to dynamic placeholder 114-2, reserved bit 206-3 corresponds to dynamic placeholder 114-3, reserved bit 206-4 corresponds to dynamic placeholder 114-4, reserved bit 206-5 corresponds to dynamic placeholder 114-5, and reserved bit 206-n corresponds to dynamic placeholder 114-n. Each of the dynamic placeholders 114-1 to 114-n represents an empty space or a blank area within the binary sequence data 204 that is generated by deleting the reserved bits 206-1 to 206-n corresponding to each of the dynamic placeholders 114-1 to 114-n. Additionally, as part of the modification of the legacy QR code 112, the terminal device identifier 124 that was included in the legacy QR code 112 is carried forward (without any modification) to be included in the incomplete QR code 110. FIG. 2E shows the incomplete QR code 110 with the dynamic placeholders 114-1 to 114-n (i.e., empty spaces or blank areas) and the terminal device identifier 124.

The deletion of the reserved bits 206-1 to 206-n to create blank areas that represent the dynamic placeholders 114-1 to 114-n is referred to as frameshifting techniques. For example, the fourth row of the binary sequence data 204 represents the bits “0001111111000”. After modifying the legacy QR code 112 by replacing the reserved bits 206-3 with a corresponding dynamic placeholder 114-3, the binary sequence data 204 for the fourth row is now represented as “000111111000”. Specifically, the bit “1” corresponding to the reserved bit 206-3 is deleted, causing the rest of the bits to shift, and illustrated in FIG. 2D by including the dynamic placeholder 114-3. The incomplete QR code 110 is also interchangeably referred to as a frameshifted QR code 110. Next, upon generating the incomplete QR code 110, processor 130 transmits the incomplete QR code 110 to terminal devices 106 (e.g., terminal device 106-1). The first phase is complete.

### Second phase: Initiate utilizing the incomplete QR code to mitigate malware threats

In the second phase, server device 102 receives the scanned image 156 of the incomplete QR code 110 from the user device 104 in response to an interaction 118 initiated between the user device 104 and the terminal device 106-1. Since the incomplete QR code 110 has dynamic placeholders 114 included in it, the system 100 is configured only to allow the interaction 118 to proceed in response to an incomplete QR code 110 being modified (by filling in the dynamic placeholders 114) into a complete QR code 120. The complete QR code 120 is transmitted to user device 104, and the interaction 118 is allowed to proceed for authentication. The second phase is now explained in detail below.

### Receive an image of the incomplete QR code

Terminal devices 106 are configured to display the incomplete QR code 110. For example, terminal device 106-1 displays the incomplete QR code 110 on display screen 154. User device 104 initiates an interaction 118 with terminal device 106-1 by capturing an image 156 of the incomplete QR code 110. The user device 104 may capture an image of the incomplete QR code 110 and may cause the transmission of the image 156 of the incomplete QR code 110 to the server device 102 by executing software instructions 152 via the network 108. Further, at least a portion of the incomplete QR code 110 is displayed on the terminal device 106-1 (or any of the terminal devices 106), and the terminal device 106-1 is within a threshold distance (e.g., 10 inches, 20 inches, etc.) from the user device 104. For example, when it is desired to capture an image 156 of the incomplete QR code 110, the user 105 may aim the camera 148 of the user device 104 toward a display screen 154 of the terminal device 106-1 where at least a first portion of the incomplete QR code 110 is displayed. The camera 148 may capture the image 156 of the incomplete QR code 110. Before initiating the authentication of the incomplete QR code 110 based on the interaction 118, the user device 104 transmits the image 156 of the incomplete QR code 110 to the server device 102 to determine if the incomplete QR code 110 is a fraudulent QR code 128. Processor 144 is configured to transmit the image 156 of the incomplete QR code 110 to the server device 102. Server device 102 receives image 156 of the incomplete QR code 110. The incomplete QR code 110 includes a terminal device identifier 124 that identifies the terminal device 106-1 and a plurality of dynamic placeholders 114. Each of the plurality of dynamic placeholders 114 comprises a blank area in the incomplete QR code 110.

### Extract the terminal device identifier

Processor 130 is configured to extract the terminal device identifier 124 from the image 156 of the incomplete QR code 110. A QR code scanner algorithm 140 may be implemented by the processor 130 executing software instructions 136, and is generally configured to scan the incomplete QR code 110 and extract encoded data from the incomplete QR code 110. For example, the QR code scanner algorithm 140 may include an algorithm that is configured to decipher and decode patterns on the incomplete QR code 110. In some examples, the patterns may include black and white blocks, lines, shapes, and the like. The QR code scanner algorithm 140 may extract an electronic code that is embedded or encoded in the pattern of the incomplete QR code 110. In some embodiments, the QR code scanner algorithm 140 may use an optical character recognition (OCR) algorithm, an image processing algorithm, and the like, to perform its functions. Thus, by utilizing the QR code scanner algorithm, the 140 processor 130 extracts the terminal device identifier 124 from the image 156 of the incomplete QR code 110.

### Access past interactions

Processor 130 is configured to access (from the memory 134) a first set of past interactions 122 from the plurality of past interactions 125 stored in the past interaction database 123. For example, the first set of past interactions 122 may be associated with (i.e., performed by in the past) the terminal device 106-1. The first set of past interactions 122 are identified from the plurality of past interactions 125 based on the extracted terminal device identifier 124.

Processor 130 upon extracting the terminal device identifier 124 from the image 156 of the incomplete QR code 110, accesses the past interaction database 123 and to analyze past interactions 125. The past interaction database 123 stores a plurality of past interactions 125 associated with the terminal devices 106. The plurality of past interactions 125 may be stored for a past period of time (e.g., past 1 hour, past day, past 1 week or past month, etc.). Past interactions 125 include past interactions performed with terminal devices 106. Each of the past interactions 125 is associated with a terminal device identifier (e.g., terminal device identifier 124) corresponding with the terminal devices 106 (e.g., terminal device 106-1). For example, processor 130 analyzes the plurality of past interactions 125 and determines that the first interaction data 122a and second interaction data 122b are both associated with the terminal device identifier 124 corresponding to terminal device 106-1. Both the first interaction data 122a and the second interaction data 122b together form the first set of past interactions 122. For example, the first interaction data 122a may include a first data value and a first location. Further, the second interaction data 122b may include a second data value and a second location. In an embodiment, the first interaction data 122a includes information associated with a last interaction performed by the terminal device 106-1, and the second interaction data 122b includes location information associated with the last interaction performed by the terminal device 106-1.

### Determine if past interaction is included in fraudulent interaction database

Processor 130 is configured to determine whether at least one of the first set of past interactions 122 is included in the plurality of fraudulent interactions 126 stored in the fraudulent interaction database 138. The fraudulent interactions 126 are those interactions that have been previously reported as fraudulent by other users. For example, processor 130 determines if the fraudulent interactions 126 store a copy of the first interaction data 122a and the second interaction data 122b. In response to the processor 130 determining that a copy of at least one of the first interaction data 122a and the second interaction data 122b included in the fraudulent interactions 126 matches to the first interaction data 122a and the second interaction data 122b, then the processor 130 denies the initiated interaction 118 between the user device 104 and the terminal device 106-1. In response to denying the initiated interaction 118, a notification message is transmitted to the user device 104. The notification message indicates to the user device 104 that the terminal device 106-1 is a bad actor and further notifies the user 105 that the interaction 118 has been denied. In an embodiment, in response to denying the initiated interaction 118, processor 130 transmits a fraudulent interaction alert to the user device 104. The fraudulent interaction alert provides a recommendation to the user device 104 to stop the initiated interaction 118 between the user device 104 and the terminal device 106-1.

Processor 130 denies the initiated interaction 118 in response to determining that the incomplete QR code 110 is associated with a bad actor. Thus, the processor 130 proactively detects a malware attack and stops damage from occurring because of the malware attack. By denying the initiated interaction 118 associated with a bad actor, bad actors are restricted from gaining access to the user device 104 and from installing malware on the user device 104. By avoiding a malware attack on the server device 102, the processor 130 mitigates damage to the user device 104 that may otherwise occur due to malware being installed on the user device 104. For example, avoiding a malware attack may avoid several types of damage typically caused by a malware attack, including, but not limited to, compromised computing performance, including slow processor performance, data redirects, frequent infection warnings, problems starting up and shutting down of user device 104, sudden loss of memory disk space, repeated system crashes and freezes, disabled security features, changes in file name and sizes, programs opening and closing themselves, or a combination thereof.

### Select the first pair of placeholders to be replaced

In response to the processor 130 determining that none of the first interaction data 122a and the second interaction data 122b are included in the fraudulent interactions 126, then processor 130 selects first dynamic placeholder 114-3 and second dynamic placeholder 114-4 from the plurality of dynamic placeholders 114 that are to be replaced. The first dynamic placeholder 114-3 and the second dynamic placeholder 114-4 are collectively referred to as the first pair of placeholders 115. The first pair of placeholders 115 are selected at non-consecutive time instants.

Processor 130 utilizes a random selection algorithm 170 to select the first pair of placeholders 115. The random selection algorithm 170 may be implemented by the processor 130 executing software instructions 136, and is generally configured to select, for example, the first pair of placeholders 115 (e.g., first dynamic placeholder 114-3 and the second dynamic placeholder 114-4) from the plurality of dynamic placeholders 114, such that random selection algorithm 170 selects the first dynamic placeholder 114-3 and the second dynamic placeholder 114-4 at non-consecutive time instants. The random selection algorithm 170 may conduct a random selection such that no two of the plurality of dynamic placeholders 114 are selected consecutively. The non-consecutive time instants are associated with the future interactions that utilize the incomplete QR code 110. For example, random selection algorithm 170 may configure the processor 130 to re-select the first pair of placeholders 115 (i.e., first dynamic placeholder 114-3 and the second dynamic placeholder 114-4) after a certain number of future interactions (e.g., ten future interactions, or any other number of future interactions may be included) associated with the incomplete QR code 110. In other words, processor 130 is configured to select any of the plurality of dynamic placeholders 114 apart from the first pair of placeholders 115 (i.e., first dynamic placeholder 114-3 and the second dynamic placeholder 114-4) until a predefined number of future interactions associated with the incomplete QR code 110 are completed. Such that no two consecutive future interactions that utilize the incomplete QR code 110 will have the same first pair of placeholders 115 (i.e., first dynamic placeholder 114-3 and the second dynamic placeholder 114-4) selected.

In an embodiment, the first pair of placeholders 115 are selected after a threshold time period expires. The threshold time period may include, e.g., after 1 hour, after 1 day, after 1 week, or after 1 month; any other time instant may also be included. For example, when processor 130 determines that the time instant is after 1 day (i.e., 24 hours), then if processor 130 selects the first dynamic placeholder 114-3 and the second dynamic placeholder 114-4 from the plurality of dynamic placeholders 114 to be replaced on Apr. 29, 2025, at 3:00 PM. Then, for any future interactions with the incomplete QR code 110, the processor 130 will not re-select the first dynamic placeholder 114-3 and the second dynamic placeholder 114-4 until after the expiration of 24 hours. In other words, processor 130 will not re-select the first dynamic placeholder 114-3 and the second dynamic placeholder 114-4 until after Apr. 29, 2025, at 3:00 PM.

In an embodiment, instead of the first pair of dynamic placeholders 115 (i.e., two placeholders from the plurality of dynamic placeholders 114), the processor 130 is configured to select any other number of placeholders 115 from the plurality of dynamic placeholders 114. For example, processor 130 may select three dynamic placeholders 115 (i.e., dynamic placeholders 114-1, 114-2, and 114-3) from the plurality of dynamic placeholders 114, such that the three dynamic placeholders 115 are selected at non-consecutive time instants. In an embodiment, instead of selecting pairs of placeholders 115, the processor 130 may select one dynamic placeholder 115 (i.e., dynamic placeholder 114-1) from the plurality of dynamic placeholders 114, such that the one dynamic placeholder 115 is selected at non-consecutive time instants.

### Modify the incomplete QR code into a complete QR code

In one or more embodiments, each of the first interaction data 122a and the second interaction data 122b of the first set of past interactions 122 is uniquely identified by a non-fungible token (NFT) 172. In an embodiment, processor 130 modifies the incomplete QR code 110 by replacing the first dynamic placeholder 114-3 of the first pair of dynamic placeholders 115 with a first non-fungible token (NFT) 172a and replacing the second dynamic placeholder 114-4 of the first pair of dynamic placeholders 115 with a second NFT 172b to generate the complete QR code 120. The first NFT 172a includes the first interaction data 122a from the first set of past interactions 122 and the second NFT 172b includes the second interaction data 122b from the first set of past interactions 122.

For example, as shown in FIG. 1, NFTs 172a and 172b are associated with first interaction data 122a and the second interaction data 122b, respectively. In one embodiment, the server device 102 may be configured to generate an NFTs 172 associated with each of the plurality of past interactions 125. The NFTs 172a-172n are collectively referred to as NFTs 172. The server device 102 may use an NFT minting device (not shown) to generate NFTs 172 associated with each of the plurality of past interactions 125. In one embodiment, the NFT minting device may be a computing node 176-1 of the plurality of computing nodes 176-1 to 176-n of a blockchain network 107. The NFT minting device may generate the NFTs 172 and transmit them to the server device 102. Server device 102 stores the NFTs 172 in its memory 134.

### Blockchain network

Blockchain network 107 includes a plurality of computing nodes 176-1 to 178-n. The computing nodes 176-1 to 178-n may include server devices, databases, or any other device to perform the functions of blockchain technology. Each of the NFTs 172 is a blockchain-based digital certificate that uniquely identifies a digital asset (e.g., first interaction data 122a and the second interaction data 122b) and thus acts as verifiable proof of ownership of the digital asset. For example, an NFT 172a may be generated for a particular digital asset (e.g., first interaction data 122a) and includes information relating to the digital asset, and further includes a unique digital signature that cannot be changed as NFT 172a is stored in a distributed network such as the blockchain network 107. Using a native digital signature scheme on the blockchain network 107, it is easy to verify the authenticity of each of the NFTs 172, their identity, their unique attributes, and their owners. Since NFTs 172 cannot be modified easily, this greatly reduces the possibility of bad actors tampering with the NFTs 172. In one embodiment, the server device 102 may leverage NFT technology to avoid unauthorized access to first interaction data 122a and/or to track down any malicious activity that has been performed in relation to first interaction data 122a. For example, the server device 102 may record information relating to first interaction data 122a in the blockchain network 107 (e.g., as part of the blockchain ledger). Since each of the first interaction data 122a and the second interaction data 122b is uniquely identified by its respective NFTs 172a and 172b, a utilization of the complete QR code 120 relating to first interaction data 122a and the second interaction data 122b may be recorded against the respective NFTs 172a and 172b in a verifiable and immutable manner, thus avoiding tampering with the history of the complete QR code 120 associated with the first interaction data 122a and the second interaction data 122b by a bad actor.

### Minting NFTs

Each of the NFTs 172 may be generated through a process called minting. Minting is a process that involves signing a blockchain transaction in the blockchain network 107 that outlines the fundamental token details, which is then broadcasted to the blockchain network 107 to trigger a smart contract function which creates the token and assigns it to its owner (e.g., user/entity associated with the first interaction data 122a and the second interaction data 122b). This minting process may be performed by an NFT minting node which may be a minting server of the blockchain network 107. For example, each of the NFTs 172a and 172b generated by the blockchain network 107 (e.g., by the NFT minting node) generally includes a unique token ID of the NFT 172a and 172b and other information related to the digital asset (e.g., the first interaction data 122a and the second interaction data 122b) identified by each of the NFTs 172a and 172b.

In one or more embodiments, once a new interaction is added to the past interactions 125 of the past interaction database 123, the server device 102 may be configured to request the NFT minting node to generate a unique NFT 172n associated with the new interaction added to the past interactions 125. Generating the NFT 172n by the NFT minting node may include generating the NFT 172n identified by a unique token ID and associating the unique token ID of the NFT 172n with the newly added interaction in the past interactions 125. In one embodiment, the NFT 172n may store a copy or a link of the newly added interaction in the past interaction database 123 in the blockchain network 107 (e.g., stored on a computing node 176-1 of the blockchain network 107).

With reference to FIG. 2F, once the NFTs 172 are generated, processor 130 identifies, for example, the NFTs 172a and 172b that correspond with first interaction data 122a and second interaction data 122b, respectively. Upon identifying the NFTs 172a and 172b, processor 130 modifies the incomplete QR code 110 by inserting the NFTs 172 and 172b at the first dynamic placeholder 114-3 and second dynamic placeholder 114-4, respectively (see FIG. 2F). In an embodiment, processor 130 selects the first dynamic placeholder 114-3 and the second dynamic placeholder 114-4 from the plurality of dynamic placeholders 114 to be replaced with NFTs 172a and 172b that correspond with the first interaction data 122a and the second interaction data 122b. In response to replacing the first dynamic placeholder 114-3 and the second dynamic placeholder 114-4 with NFTs 172a and 172b, respectively, the incomplete QR code 110 is modified or transformed into the complete QR code 120. This complete QR code 120 includes the NFTs 172a and 172b, as well as the remaining dynamic placeholders 114-1, 114-2, 114-5, and 114-6 of the plurality of dynamic placeholders 114, as well as the terminal device identifier 124.

### Allow the initiated interaction

Processor 130, in response to generating the complete QR code 120, allows the initiated interaction 118 between the user device 104 and the terminal device 106-1 to proceed with authenticating the interaction 118. The authenticating of interaction 118 may be performed by server device 102 or any other third-party service provider. Further, processor 130, in response to generating the complete QR code 120, processor 130 transmits the complete QR code 120 to the user device 104. The transmission of the complete QR code 120 to the user device 104 may include a notification message. The notification message indicates to the user device 104 that the terminal device 106-1 is not a bad actor and further notifies the user 105 to proceed with the authentication of interaction 118.

In an embodiment, the terminal device 106-1 may be a point of sale (POS) device, and the user device 104 scans the incomplete QR code 110 to initiate the interaction 118 to purchase a product at an establishment associated with the terminal device 106-1.

FIGS. 3A-3B illustrates an example flowchart of method 300 for implementing a frameshifted identifier to mitigate malware threats, in accordance with an embodiment of the present disclosure. For example, one or more operations of method 300 may be implemented, at least in part, in the form of software instructions 136 of FIG. 1, stored on a tangible non-transitory machine-readable medium or a computer-readable medium (e.g., memory 134 of FIG. 1) that, when run by one or more processors (e.g., processor 130 of FIG. 1) may cause the one or more processors to perform operations of the method 300.

Referring to FIG. 3A, at operation 302, processor 130 of the server device 102 is configured to receive request 166 from one of the terminal devices 106 (e.g., terminal device 106-1) to receive an incomplete QR code 110.

At operation 304, processor 130 of the server device 102 accesses (from the memory 134) a legacy QR code 112 associated with the terminal device identifier 124.

At operation 306, processor 130 of the server device 102 converts the legacy QR code 112 (e.g., by decoding the legacy QR code 112) into a binary format 202. The binary format 202 represents a binary format version of the legacy QR code 112. FIG. 2C shows a binary sequence data 204 included within the binary format 202. The binary sequence data 204 represents rows and columns of binary bits (0 or 1) associated with the legacy QR code 112.

At operation 308, processor 130 of the server device 102 identifies one or more reserved bits 206-1 to 206-n within each row or column of the binary sequence data 204 based on predefined pattern detection rules 168a-n stored in the rules database 168.

At operation 310, processor 130 of the server device 102 modifies the legacy QR code 112 by replacing each of the reserved bits 206-1 to 206-n with a corresponding dynamic placeholder 114-1 to 114-n to generate the incomplete QR code 110. The plurality of dynamic placeholders 114-1 to 114-n are collectively referred to as dynamic placeholders 114.

At operation 312, processor 130 of the server device 102 receives the scanned image 156 of the incomplete QR code 110 from the user device 104 in response to an interaction 118 initiated between the user device 104 and the terminal device 106-1.

At operation 314, processor 130 of the server device 102 extracts the terminal device identifier 124 from the image 156 of the incomplete QR code 110.

At operation 316, processor 130 of the server device 102 access (from the memory 134) a first set of past interactions 122 from the plurality of past interactions 125 stored in the past interaction database 123.

At operation 318, processor 130 of the server device 102 determines whether at least one of the first set of past interactions 122 is included in the fraudulent interactions 126 stored in the fraudulent interaction database 138. In response to the processor 130 determining that none of the first interaction data 122a and the second interaction data 122b are included in the fraudulent interactions 126, the method proceeds to operation 320.

At operation 320, processor 130 of the server device 102 selects first dynamic placeholder 114-3 and second dynamic placeholder 114-4 from the plurality of dynamic placeholders 114 that are to be replaced.

At operation 322, processor 130 of the server device 102 modifies the incomplete QR code 110 by replacing the first dynamic placeholder 114-3 of the first pair of dynamic placeholders 115 with a first non-fungible token (NFT) 172a and replacing the second dynamic placeholder 114-4 of the first pair of dynamic placeholders 115 with a second NFT 172b to generate the complete QR code 120.

At operation 324, processor 130 of the server device 102 allows the initiated interaction 118 between the user device 104 and the terminal device 106-1 to proceed with authenticating the interaction 118.

Back at operation, 318 in response to the processor 130 determining that a copy of at least one of the first interaction data 122a and the second interaction data 122b included in the fraudulent interactions 126 matches to the first interaction data 122a and the second interaction data 122b, then the method proceeds to operation 326. At operation 326, processor 130 denies the initiated interaction 118 between the user device 104 and the terminal device 106-1.

### Quarantine Sector

In an embodiment, processor 130 is configured to quarantine image 156 of the incomplete QR code 110 at a quarantine sector 142 within the memory 134 of the server device 102 as soon as it receives the image 156 generated in response to an interaction 118 initiated between a user device 104 and a terminal device 106-1. Once the image 156 is quarantined in the quarantine sector 142, the server device 102 performs the above-explained operations (within the quarantine sector 142) of determining if the incomplete QR code 110 is associated with a bad actor and further modifying the incomplete QR code 110 into the complete QR code 120. Accordingly, the quarantine sector 142 is a memory sector created by processor 130 such that software programs, software applications, or any software stored in this quarantine sector 142 is not permitted or restricted from acting on files outside the quarantine sector 142. Accordingly, in response to the processor 130 determining that a copy of at least one of the first interaction data 122a and the second interaction data 122b is included in the fraudulent interactions 126, then the processor 130 denies the initiated interaction 118 between the user device 104 and the terminal device 106-1. In response to denying the initiated interaction 118, the image 156 of the incomplete QR code 110 is stored in the quarantine sector 142 as a fraudulent QR code 128. In an embodiment, processor 130 is configured to identify malicious data from the fraudulent QR code 128 and mitigate the malicious attack corresponding to the malicious data by modifying the fraudulent QR code 128 to remove the identified malicious data and generate a sanitized version of the fraudulent QR code 128. Thus, any malicious attacks are isolated in the quarantine sector 142 and thus cannot harm or attack the rest of the components outside the quarantine sector 142. In this manner, malware attacks are mitigated by physically isolating the image 156 of the incomplete QR code 110 in the quarantine sector 142 and proactively. Thus, by isolating malware attacks within a quarantine sector 142, the security of the server devices 102 and information stored in the server device 102 is not compromised. In an embodiment, the above operations 312 to 326 associated with the method 300 with reference to FIGS. 3A-3B may be performed within the quarantine sector 142.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112(f), as it exists on the date of filing hereof, unless the words “means for” or “step for” are explicitly used in the particular claim.

What is claimed is:

1. A system comprising:
a memory operable to store an image of a first quick response (QR) code, a plurality of past interactions, wherein the plurality of past interactions are performed by a plurality of terminal devices; and
a processor operably coupled to the memory and configured to:
electronically receive the image of the first QR code from a user device in response to an interaction initiated between a user device and a terminal device of the plurality of terminal devices, wherein the interaction is initiated by the user device capturing the image of the first QR code displayed at the terminal device, wherein the first QR code includes a terminal device identifier that identifies the terminal device and a plurality of dynamic placeholders, and wherein each of the plurality of dynamic placeholders comprises a blank area in the first QR code;
decode the first QR code and extract the terminal device identifier from the image of the first QR code;
access, from the memory, a first set of past interactions from the plurality of past interactions performed by the terminal device, wherein the first set of past interactions are identified from the plurality of past interactions based on the extracted terminal device identifier;
determine whether at least one of the first set of past interactions is included in a plurality of fraudulent interactions stored in the memory;
in response to determining that none of the first set of past interactions are included in the plurality of fraudulent interactions, select a first pair of placeholders from the plurality of dynamic placeholders that are to be replaced, wherein the first pair of placeholders comprises a first dynamic placeholder and a second dynamic placeholder, and wherein the first pair of placeholders are selected at non-consecutive time instants;
modify the first QR code by replacing the first dynamic placeholder with a first non-fungible token (NFT) and replacing the second dynamic placeholder with a second NFT to generate a second QR code, wherein the first NFT comprises a first interaction data from the first set of past interactions and the second NFT comprises a second interaction data from the first set of past interactions; and
in response to generating the second QR code, allow the initiated interaction between the user device and the terminal device to proceed with authenticating the interaction and transmit the second QR code to the user device.

2. The system of claim 1, wherein the processor is further configured to:
in response to determining that at least one of the first set of past interactions is included in the plurality of fraudulent interactions, deny the initiated interaction between the user device and the terminal device.

3. The system of claim 1, wherein the first interaction data comprises information associated with a last interaction performed by the terminal device, and the second interaction data comprises location information associated with the last interaction performed by the terminal device.

4. The system of claim 1, wherein the processor is further configured to:
access, from the memory, a third QR code associated with a terminal device of the plurality of terminal devices; and
decode the third QR code into a binary format, wherein the binary format represents binary sequence data associated with the third QR code, and wherein the binary sequence data comprises a plurality of reserved bits.

5. The system of claim 4, wherein the processor is further configured to:
identify the plurality of reserved bits from within the binary sequence data, wherein each of the plurality of reserved bits is a bit corresponding to the binary sequence data;
modify the third QR code by replacing each of the bit corresponding to the plurality of reserved bits with a corresponding dynamic placeholder to generate the first QR code; and
transmit the first QR code to the terminal device.

6. The system of claim 1, wherein the processor is further configured to:
in response to determining that none of the first set of past interactions are included in the plurality of fraudulent interactions, select the first dynamic placeholder, the second dynamic placeholder, and a third dynamic placeholder from the plurality of dynamic placeholders that are to be replaced, and wherein the first dynamic placeholder, the second dynamic placeholder, and a third dynamic placeholder are selected at non-consecutive time instants.

7. The system of claim 1, wherein the processor is further configured to:
in response to determining that at least one or more of the first set of past interactions are included in the plurality of fraudulent interactions, transmit a fraudulent interaction alert to the user device, wherein the fraudulent interaction alert provides a recommendation to stop the initiated interaction between the user device and the terminal device.

8. A method comprising:
electronically receiving an image of a first QR code from a user device in response to an interaction initiated between a user device and a terminal device of a plurality of terminal devices, wherein the interaction is initiated by the user device capturing the image of the first QR code displayed at the terminal device, wherein the first QR code includes a terminal device identifier that identifies the terminal device and a plurality of dynamic placeholders, and wherein each of the plurality of dynamic placeholders comprises a blank area in the first QR code;
decoding the first QR code and extracting the terminal device identifier from the image of the first QR code;
accessing, from a memory, a first set of past interactions from a plurality of past interactions performed by the terminal device, wherein the first set of past interactions are identified from the plurality of past interactions based on the extracted terminal device identifier;
determining whether at least one of the first set of past interactions is included in a plurality of fraudulent interactions stored in the memory;
in response to determining that none of the first set of past interactions are included in the plurality of fraudulent interactions, selecting a first pair of placeholders from the plurality of dynamic placeholders that are to be replaced, wherein the first pair of placeholders comprises a first dynamic placeholder and a second dynamic placeholder, and wherein the first pair of placeholders are selected at non-consecutive time instants;
modifying the first QR code by replacing the first dynamic placeholder with a first non-fungible token (NFT) and replacing the second dynamic placeholder with a second NFT to generate a second QR code, wherein the first NFT comprises a first interaction data from the first set of past interactions and the second NFT comprises a second interaction data from the first set of past interactions; and
in response to generating the second QR code, allowing the initiated interaction between the user device and the terminal device to proceed with authenticating the interaction and transmitting the second QR code to the user device.

9. The method of claim 8, further comprising:
in response to determining that at least one of the first set of past interactions is included in the plurality of fraudulent interactions, denying the initiated interaction between the user device and the terminal device.

10. The method of claim 8, wherein the first interaction data comprises information associated with a last interaction performed by the terminal device, and the second interaction data comprises location information associated with the last interaction performed by the terminal device.

11. The method of claim 8, further comprising:
accessing, from the memory, a third QR code associated with a terminal device of the plurality of terminal devices; and
decoding the third QR code into a binary format, wherein the binary format represents binary sequence data associated with the third QR code, and wherein the binary sequence data comprises a plurality of reserved bits.

12. The method of claim 11, further comprising:
identifying the plurality of reserved bits from within the binary sequence data, wherein each of the plurality of reserved bits is a bit corresponding to the binary sequence data;
modifying the third QR code by replacing each of the bit corresponding to the plurality of reserved bits with a corresponding dynamic placeholder to generate the first QR code; and
transmitting the first QR code to the terminal device.

13. The method of claim 8, further comprising:
in response to determining that none of the first set of past interactions are included in the plurality of fraudulent interactions, selecting the first dynamic placeholder, the second dynamic placeholder, and a third dynamic placeholder from the plurality of dynamic placeholders that are to be replaced, and wherein the first dynamic placeholder, the second dynamic placeholder, and a third dynamic placeholder are selected at non-consecutive time instants.

14. The method of claim 8, further comprising:
in response to determining that at least one or more of the first set of past interactions are included in the plurality of fraudulent interactions, transmitting a fraudulent interaction alert to the user device, wherein the fraudulent interaction alert provides a recommendation to stop the initiated interaction between the user device and the terminal device.

15. A non-transitory computer-readable medium storing instructions that, when executed by a processor, cause the processor to:
electronically receive an image of a first QR code from a user device in response to an interaction initiated between a user device and a terminal device of a plurality of terminal devices, wherein the interaction is initiated by the user device capturing the image of the first QR code displayed at the terminal device, wherein the first QR code includes a terminal device identifier that identifies the terminal device and a plurality of dynamic placeholders, and wherein each of the plurality of dynamic placeholders comprises a blank area in the first QR code;
decode the first QR code and extract the terminal device identifier from the image of the first QR code;
access, from a memory, a first set of past interactions from a plurality of past interactions performed by the terminal device, wherein the first set of past interactions are identified from the plurality of past interactions based on the extracted terminal device identifier;
determine whether at least one of the first set of past interactions is included in a plurality of fraudulent interactions stored in the memory;
in response to determining that none of the first set of past interactions are included in the plurality of fraudulent interactions, select a first pair of placeholders from the plurality of dynamic placeholders that are to be replaced, wherein the first pair of placeholders comprises a first dynamic placeholder and a second dynamic placeholder, and wherein the first pair of placeholders are selected at non-consecutive time instants;
modify the first QR code by replacing the first dynamic placeholder with a first non-fungible token (NFT) and replacing the second dynamic placeholder with a second NFT to generate a second QR code, wherein the first NFT comprises a first interaction data from the first set of past interactions and the second NFT comprises a second interaction data from the first set of past interactions; and
in response to generating the second QR code, allow the initiated interaction between the user device and the terminal device to proceed with authenticating the interaction and transmit the second QR code to the user device.

16. The non-transitory computer-readable medium of claim 15, further comprising:
in response to determining that at least one of the first set of past interactions is included in the plurality of fraudulent interactions, deny the initiated interaction between the user device and the terminal device.

17. The non-transitory computer-readable medium of claim 15, wherein the first interaction data comprises information associated with a last interaction performed by the terminal device, and the second interaction data comprises location information associated with the last interaction performed by the terminal device.

18. The non-transitory computer-readable medium of claim 15, further comprising:
access, from the memory, a third QR code associated with a terminal device of the plurality of terminal devices; and
decode the third QR code into a binary format, wherein the binary format represents binary sequence data associated with the third QR code, and wherein the binary sequence data comprises a plurality of reserved bits.

19. The non-transitory computer-readable medium of claim 18, further comprising:
identify the plurality of reserved bits from within the binary sequence data, wherein each of the plurality of reserved bits is a bit corresponding to the binary sequence data;
modify the third QR code by replacing each of the bit corresponding to the plurality of reserved bits with a corresponding dynamic placeholder to generate the first QR code; and
transmit the first QR code to the terminal device.

20. The non-transitory computer-readable medium of claim 15, further comprising:
in response to determining that none of the first set of past interactions are included in the plurality of fraudulent interactions, select the first dynamic placeholder, the second dynamic placeholder, and a third dynamic placeholder from the plurality of dynamic placeholders that are to be replaced, and wherein the first dynamic placeholder, the second dynamic placeholder, and a third dynamic placeholder are selected at non-consecutive time instants.
